(19) United States
(12) Patent Application Publication
(10) Pub. No.: US 2017/0251072 A1
(43) Pub. Date: Aug. 31, 2017

(54) SYSTEM AND METHOD FOR ANNOTATING CLIENT-SERVER TRANSACTIONS

(71) Applicant: Symantec Corporation, Mountain View, CA (US)

(72) Inventors: Michael D. Rinehart, San Jose, CA (US); Michael T. Busha, Menlo Park, CA (US)

(21) Appl. No.: 15/186,053

(22) Filed: Jun. 17, 2016

Related U.S. Application Data
(60) Provisional application No. 62/244,994, filed on Oct. 22, 2015.

(51) Int. Cl. H04L 29/08; H04L 29/06

(52) U.S. Cl. CPC H04L 67/2804; H04L 67/42

(57) ABSTRACT

According to one embodiment, a method for annotating client-server transactions with a computer executing software comprises receiving a stream of transactional data associated with a plurality of events on the computer, wherein the plurality of events correspond to one or more actions taken by a user of a computer, and partitioning the stream of transactional data into a plurality of portions. The method further comprises sorting the plurality of portions into one or more groups based on the similarity of one portion of the plurality of portions to another portion of the plurality of portions, and receiving non-transactional data, comprising information about the plurality of events, from the computer. The method may also comprise identifying, for each group of the one or more groups, based on the non-transactional data, a possible action of the one or more actions taken by the user and labeling each group based on the identification.

### TECHNICAL FIELD

This disclosure relates in general to client-server transactions and more particularly to a system and method for annotating client-server transactions.

### BACKGROUND

The exchanges between a client computer and a server make up client-server transactional data. Client-server transactional data may be used by file monitors to ascertain the underlying actions taken by a user of the client computer. However, in many instances, the format of client-server transactional data is meaningless to a file monitor. As a result, file monitors tasked with monitoring a user's interaction with a remote service may spend a lot of time learning the syntax used by an unknown server.

### SUMMARY OF THE DISCLOSURE

According to one embodiment, a method for annotating client-server transactions with a computer executing software comprises receiving a stream of transactional data associated with a plurality of events on the computer, wherein the plurality of events correspond to one or more actions taken by a user of a computer, and partitioning the stream of transactional data into a plurality of portions. The method further comprises sorting the plurality of portions into one or more groups based on the similarity of one portion of the plurality of portions to another portion of the plurality of portions, and receiving non-transactional data, comprising information about the plurality of events, from the computer. The method may also comprise identifying, for each group of the one or more groups, based on the non-transactional data, a possible action of the one or more actions taken by the user and labeling each group based on the identification.

Certain embodiments may provide one or more technical advantages. For example, an embodiment of the present disclosure may generate human-readable descriptions of log files thereby reducing the cost associated with the manual review and analysis of client-server transactional data. As another example, an embodiment of the present disclosure may result in higher quality, or more accurate, annotations of client-server transactional data. Other technical advantages will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

FIG. 1 is a schematic illustrating is an example network environment for a system that annotates client-server transactions, according to certain embodiments;

FIG. 2 is a flow chart illustrating an example method for annotating client-server transactions, according to one embodiment of the system of FIG. 1;

FIG. 3 is a schematic illustrating a stream of transactional data before it is partitioned in accordance with the method of FIG. 2, according to certain embodiments;

FIG. 4 is a schematic illustrating an example of non-transactional data (an internal representation of a display related to a hover event) that may be received by the system of FIG. 1, according to certain embodiments;

FIGS. 5A-5D are flow diagrams illustrating different embodiments of annotating client-server transactions according to the systems and methods of the present disclosure; and

FIG. 6 is a block diagram illustrating an example computer system that may execute the log file correlator for annotating client-server transactions.

### DETAILED DESCRIPTION OF THE DISCLOSURE

The ability to determine and label actions of a user of a computer may be critical to monitoring a user's interaction with a remote service. For example, user action information may be used to detect anomalous behavior that compromises the security of a remote service. However, determining a user action by viewing client-server transactional data may be difficult because a single user action may include numerous transactions that are not indicative or even suggestive of a particular user action. This may be because one or more arbitrary actions are generated as a result of a user action. For example, a transaction involving the removal of a file may include the following request-response pair: a user selects a file by clicking (request) and HTTP server updates the web page to show the file is selected (response). Viewing this transaction in isolation, it would be difficult to determine that this request-response pair is actually associated with the user action “remove file.” Rather, a file monitor may associate this transaction with any number of user actions because the transaction is arbitrary. Thus, there exists a need for a system that may meaningfully interpret log file transaction information to detect corresponding user action.

The teachings of the disclosure recognize the benefits of correlating log file transaction information with interactions of a user to determine a corresponding user action. The following describes systems and methods of annotating client-server transactions for providing these and other desired features.

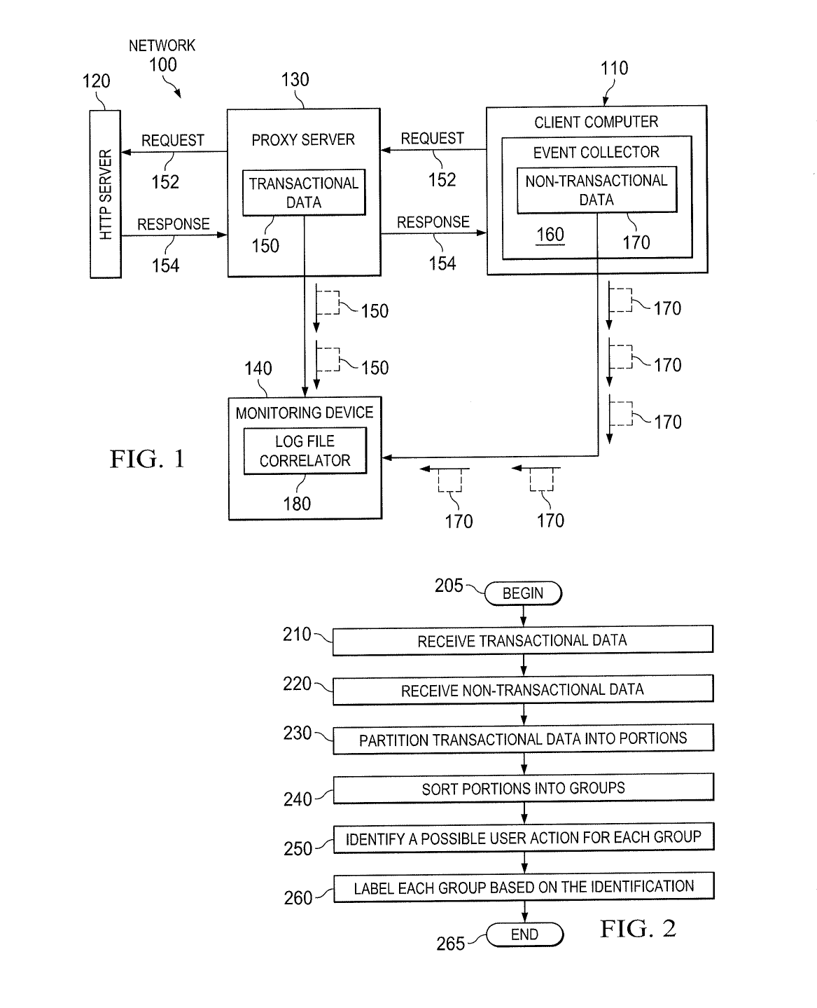

FIG. 1 illustrates a network 100 associated with client-server transactions. Network 100 may include a client computer 110, an HTTP server 120, a proxy server 130, and a monitoring device 140 that are each communicably coupled to one another.

In general, the teachings of this disclosure recognize using a log file correlator 180 to correlate transactional data with non-transactional data to annotate client-server transactions. Monitoring device 140 may receive transactional data 150 (representing the exchanges between client computer 110 and HTTP server 120) and non-transactional data 170 (representing information collected by event collector 160 relating to transactional data 150). Executing log file correlator 180 on monitoring device 140 prompts the annotation of log file transactions by correlating transactional data 150 with non-transactional data 170. Annotating log files may facilitate the identification of actions taken by a user of client computer 110.

Network 100 may refer to any interconnecting system capable of transmitting audio, video, signals, data, messages, or any combination of the preceding. Network 100 may include all or a portion of a public switched telephone network, a public or private data network, a local area network (LAN), an ad hoc network, a personal area network (PAN), a metropolitan area network (MAN), a wide area network (WAN), a local, regional, or global communication or computer network such as the Internet, an enterprise intranet, or any other suitable communication link, including combinations thereof. One or more portions of one or more of these networks may be wired or wireless. Example wireless networks 100 may include a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these.

Client computer 110 may be an electronic device including hardware, software, or embedded logic components or a combination of two or more such components and capable of carrying out the appropriate functionalities implemented or supported by client computer 110. As an example and not by way of limitation, a client computer 110 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client computer 140.

Client computer 110 may be communicatively coupled to one or more components of network 100 (e.g., HTTP server 120, proxy server 130, and monitoring device 140). In some embodiments, client computer 110 may include a web browser, such as MICROSOFT INTERNET EXPLORER, GOOGLE CHROME, or MOZILLA FIREFOX, and may have one or more add-ons, plug-ins, or other extensions (e.g., event collector 160). A user of client computer 110 may enter a Uniform Resource Locator (URL) or other address directing the web browser to a particular server, and the web browser may generate a Hyper Text Transfer Protocol (HTTP) request (e.g. request 152) and communicate the HTTP request to HTTP server 120. The server may accept the HTTP request and communicate to client computer 110 one or more files responsive to the HTTP request (e.g. response 154). The responsive files may include one or more Hyper Text Markup Language (HTML) files, EXtensible Markup Language (XML) files, JavaScript Object Notation (JSON) files, Cascading Style Sheets (CSS) files, pictures, other files, or any other suitable data that is transferable over HTTP. Client computer 110 may render a webpage based on the responsive files from the server for presentation to a user. Although this disclosure may specifically describe annotating HTTP transactional data, this disclosure recognizes annotating Hyper Text Transfer Protocol Secure (HTTP/S) transactional data or any other transactional data related to any suitable network protocol.

Client computer 110 includes an event collector 160 in some embodiments. Event collector 160 may be configured to collect non-transactional data 160 about events that occurred on client computer 110. In some embodiments, event collector 160 captures non-transactional information about events that occurred within client-side software (e.g., non-transactional data 170). For example, event collector 160 may capture information related to a user's interaction with a web browser and/or an application running on client computer 110. As used herein, an interaction refers to any interaction with a software application that is recognized by the software and may result in a change in the software's state or generate an output by the software. In some embodiments, event collector 160 may be an extension of client-side software (e.g., a browser plugin). In other embodiments, event collector 160 may be a portion of code introduced into the code of a client-side software.

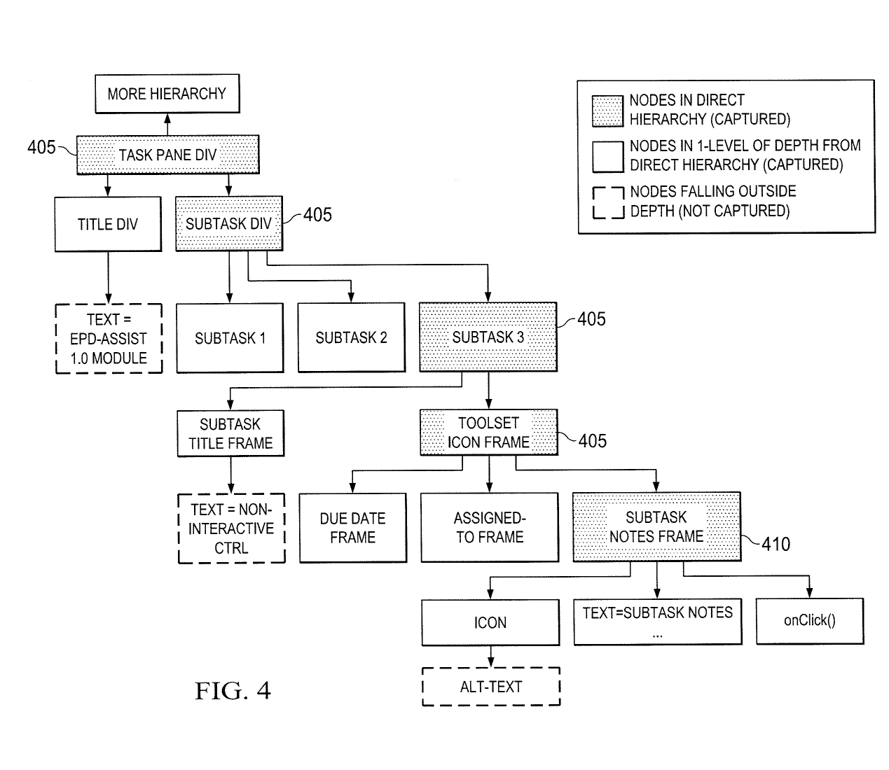

The non-transactional data 170 captured by event collector 160 may be stored in an event log (see e.g., the event log illustrated and described in reference to FIG. 4 below). The event log may include non-transactional data 170 such as a timestamp for a user event and data regarding the trigger for the user event. As examples, a trigger for an event may include a mouse click, a mouse hover, a keyboard entry, and/or a drag, tap, or pinch by a mouse, finger, or stylus. Although this disclosure describes specific event triggers, this disclosure contemplates any suitable user interaction with client computer 110 that may trigger an event.

Non-transactional data 170 may include information related to the state of the software's display at the time of the event. For example, information about the display at the time of the event may include a complete or partial screenshot of the display, data processed from a screenshot, and/or data structures resulting from the processing of all or part of the internal representation of the display. For example, an internal representation may be a hierarchical tree such as a Document Object Model (“DOM”) and/or Qt Modeling Language. An internal representation of the display will be described in further detail below in reference to FIG. 4.

Non-transactional data 170 may also include the location within the display at which the event occurred. This disclosure contemplates that “location” may refer to any information from which it can be approximately inferred where in the coordinate system of the display the event can be understood as occurring. For example, location data may be represented as a coordinate pair that corresponds to the location of a mouse click. As another example, location data may be represented as the path of nodes in a tree representation of the display which leads to a leaf-node where the strokes of a keyboard are being recorded. As yet another example, location data may be represented by a sub-window in the user interface where the user tapped the screen.

Non-transactional data 170 collected by event collector 160 may be sent over the network for further processing. For example, client computer 110 may send non-transactional data 170 through proxy server 130 to monitoring device 140. As another example, client computer 110 may send non-transactional data 170 directly to monitoring device 140. In some embodiments, the non-transactional data is received by a communication interface monitoring device 140. Although this disclosure describes particular ways in which monitoring device 140 receives non-transactional data 170, this disclosure recognizes any suitable way in which monitoring device 140 receives non-transactional data 170.

HTTP server 120 may be a web server in some embodiments. HTTP server 120 may process a request 152 from a client computer (e.g., client computer 110) and return a response 154 to the client computer. This request-response exchange is referred to herein as a single transaction.

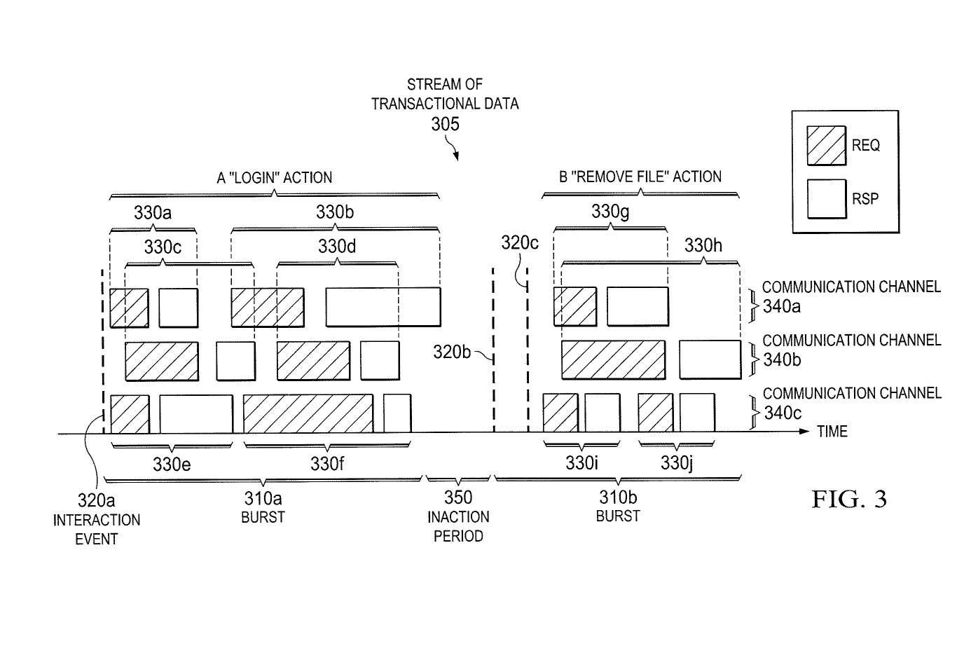

One or more transactions between client computer 110 and HTTP server 120 may comprise client-server transactional data (also referred to herein as “transactional data”) 150. Transactional data 150 may represent all exchanges (transactions) between client computer 110 and HTTP server 120. In some embodiments, transactional data 150 may be a single request-response pair (152 and 154). In other embodiments, transactional data 150 may comprise more than one request-response pair (152 and 154). Client-server transactional data 150 will be described in further detail below in reference to FIG. 3.

Proxy server 130 may be present on network environment 100 in some embodiments. Proxy server 130 may serve as an intermediary between a client computer (e.g., client computer 110) and a web server (e.g., HTTP server 120). In some embodiments, proxy server 130 may record client-server transactional data 150.

Client-server transactional data 150 may be recorded as a continuous stream of transactions (e.g., stream of transactional data 305 of FIG. 3). In some embodiments, proxy server 130 may save transactional data 150 to an internal storage drive. In other embodiments, the transactional data recorded by proxy server 130 may be saved to an external storage drive such as a storage or memory of monitoring device 140. Although this disclosure describes and illustrates a proxy server as recording the transactional data, this disclosure recognizes any suitable component configured to capture transactional data 150 between client computer 110 and server 120.

Monitoring device 140 may be present on network environment 100 in some embodiments. In some embodiments, monitoring device 140 is a computer system such as computer system 600 of FIG. 6. In some embodiments, monitoring device 140 may be configured to store client-server transactional data 150. Monitoring device 140 may also be configured to store Log file correlator 180. Log file correlator 180 is a data processing program that facilitates the annotation of client-server transactions 150 according to embodiments of the present invention. In some embodiments, monitoring device 140 may also store the non-transactional data 170.

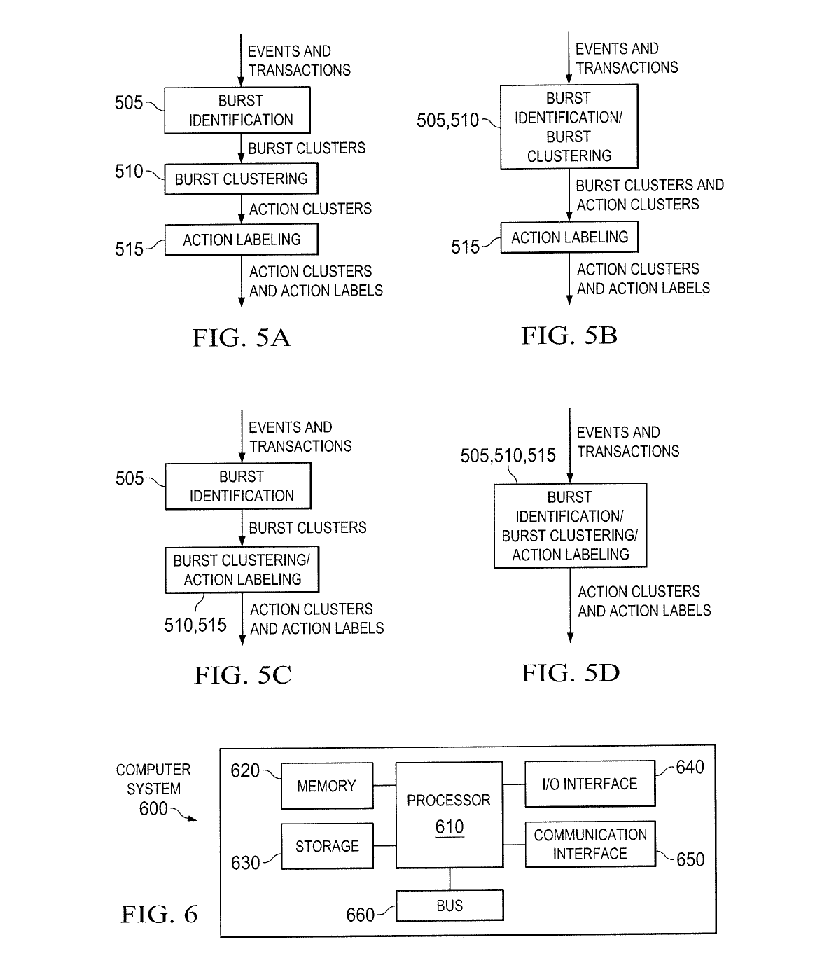

In some embodiments, log file correlator 180 annotates log file transactions according to a method 200 described below in reference to FIG. 2. Transactional data 150, and the partitioning thereof is illustrated and described in reference to FIG. 3. Non-transactional data, specifically an internal representation of a web site, is illustrated and described below in reference to FIG. 4. Various flows of processing transactional and non-transactional information, according to certain embodiments of the present disclosure, are illustrated and described in reference to FIGS. 5A-5D. Finally, a computer system, such as monitoring device 140 configured to run Log file correlator, is illustrated and described in reference to FIG. 6.

FIG. 2 is a flow chart illustrating a method 200 for annotating client-server transactions. In some embodiments, log file correlator 180 of FIG. 1 may perform the method of FIG. 2. The method of FIG. 2 may represent an algorithm that is stored on a computer readable medium, such as a memory of a controller (e.g., the memory 620 of FIG. 6.

Turning now to FIG. 2, the method 200 may begin in a step 205. At a step 210, log file correlator 180 receives transactional data. In some embodiments, the transactional data is received by monitoring device 140 from proxy server 130. In some embodiments, the transactional data is received by a communication interface of monitoring device 140.

As described above, transactional data may refer to the exchanges between client computer 110 and HTTP network 120. Transactional data may be received as a single stream of HTTP traffic for a specific period of time. The transactional data may comprise a plurality of transactions corresponding to events between client computer 110 and HTTP server 120. These events may be related to a user action. As used herein, a user action may refer to an objective of a user of a client-computer that corresponds to one or more events that occur with a remote service through client software. In some embodiments, the user actions may be actions that are known to be supported by a cloud application. For example, a user action may be one of the following: send email, receive email, upload, download, send file, move file, delete file, send instant message, receive instant message, add contact, etc. Although this disclosure describes specific types of user actions, this disclosure contemplates any suitable action of a user of client computer 110. In some embodiments, the method 200 may continue to a step 220.

At step 220, log file correlator 180 receives non-transactional data. In some embodiments, log file correlator 180 receives the non-transactional data from event collector 160 of client computer 110. Non-transactional data may include a timestamp for a user event, data regarding the trigger for the user event, state of the display at the time of the user event, and/or location within the display at which the user event occurred. In some embodiments, the method continues to a step 230.

At a step 230, log file correlator 180 partitions the transactional data into portions. As used herein, the term “portions” may be used interchangeably with the word “bursts.” For example, in reference to FIG. 3, the portions are referred to as bursts of transactions. In some embodiments, the partitioning of transactional data is deterministic. As used herein, deterministic partitioning refers to an algorithm that produces the same portions from a single set of transactional data even when the algorithm is executed more than one time. In other embodiments, the partitioning of transactional data is randomized. As used herein, randomized partitioning refers to an algorithm that may produce different portions from a single set of transactional data when the algorithm is executed more than once. Partitioning the transactional data may be performed as a finite sequence of steps or iteratively as an optimization or statistical estimation. In some embodiments, partitioning the transactional data is based on transaction interarrival times (i.e., the time between the occurrence of transactions that occur sequentially in time, as measured from the start or end time of one transaction); the relationship between the times of the transactions and the collected event data; the content, length, and/or text features of the transactions; and/or the content, length, and/or text features of events. Transactional data 150 may be partitioned such that each transaction belongs to a single portion or is assigned a value indicating a probability of belonging to one or more portions.

Typically, transactions related to a single user action occur at or near the same time and are followed by a pause, or period of inaction. As used herein, a period of inaction may also refer to a period of time that is not associated, or does not correspond to, non-transactional data 170. Thus, identifying transactions that occur closely in time (a portion/burst) may be indicative of a single user action.

Transactional data may include a timestamp for every transaction. In some embodiments, log file correlator 180 partitions the transactional data into portions of transactions based on the timestamp of each transaction. For example, all transactions within a single portion may occur at or near the same time. In some embodiments, transactional data is partitioned based on a period of inaction. For example, a first set of transactions corresponding to a first portion may occur within a first period of time, this first portion may be followed by a period of inaction, which is in turn followed by a second set of transactions corresponding to a second portion that occur within a second period of time. In some embodiments, the method 200 may continue to a step 240.

At step 240, log file correlator 180 sorts the portions into one or more groups. In some embodiments, the portions are sorted into groups based on the similarity of one portion to another portion. The groups may be sorted based on similarity because of the likelihood that similar portions correspond to the same user action. Thus, in some embodiments, the number of groups created by log file correlator 180 corresponds to the number of user actions associated with the stream of transactional data 150. In other embodiments, the number of groups created by log file correlator 180 is greater than the number of user actions associated with the stream of transactional data 150. For example, in some embodiments, log file correlator 180 creates more groups than user actions in instances when transactional data 150 does not correspond to non-transactional data (e.g., transactional data 150 recorded during a period of inaction). As another example, log file correlator 180 may create more groups than user actions in instances when the traffic associated with a single user action is distinguishable (e.g., the traffic associated with a file download may be distinguishable from the traffic associated with a folder download). In yet other embodiments, log file correlator 180 may create less groups than user actions. This may occur, for example, when traffic for two separate user actions is almost identical (e.g., traffic for user action “rename” may be almost identical to traffic for user action “move”).

Portions may be sorted such that each portion belongs to a single group in some embodiments. In other embodiments, portions may be sorted based on a probability of belonged-ness to a particular group. For example, in some embodiments, a portion may be assigned a value indicating a probability that the portion belongs to one or more groups. The probability of belonged-ness may be determined by any reasonable measure.

In some embodiments, sorting the portions into one or more groups is based on the textual and/or structural similarity of all transactions in a portion; the textual and/or structural similarity of the most unique transaction in a portion; the order in which highly similar transactions occur across different portions; and/or the regularity of differences that are present in highly similar transactions from different portions. In some embodiments, information about the portion itself may be a useful measure of similarity for sorting portions into groups (e.g., the number of transactions in a portion).

Determining whether one portion is similar to another portion comprises measuring the similarity of one portion to another in some embodiments. For example, in some embodiments similarity is determined based on a statistical analysis. For example, in some embodiments, the cosine difference is calculated between one portion and another portion.

Similarity is determined based on a threshold in some embodiments. For example, in some embodiments, the cosine difference between two portions is compared to a threshold. In some embodiments, two portions are determined to be similar if the cosine difference is less than or equal to the threshold. In other embodiments, two portions are determined to be dissimilar if the cosine difference is greater than the threshold.

Determining that two portions are similar comprises comparing the transactions of the portions in some embodiments. For example, a first portion may include five transactions and a second portion may include four transactions. In such a case, the system may determine that the two portions are similar because they share three similar transactions. In other embodiments, similarity of two portions may be determined by comparing the non-transactional data 170 of the two portions. Although this disclosure describes specific ways of determining similarity, similarity may be determined in any suitable manner.

Each group comprises one or more portions in some embodiments. In other embodiments, one portion may comprise its own group. For example, a portion that is not similar to any other portion may comprise its own group corresponding to a specific user action.

A portion that cannot be sorted into a group of two or more portions may be considered dissimilar. In some embodiments, one or more dissimilar portions may comprise one or more groups. Such a group may be considered “noisy” because none of the portions in the group are similar. In some embodiments, a “noisy” group may be excluded from further processing. In other embodiments, the “noisy” groups may be used to establish a confidence on the resulting annotations. In some embodiments, the method 200 continues to a step 250.

At step 250, log file correlator 180 identifies a possible user action corresponding to each group based on the non-transactional data. In some embodiments, identifying a possible user action based on non-transactional data includes correlating non-transactional data with transactional data. In some other embodiments, identifying a possible user action comprises determining a probability that the non-transactional data corresponds to the transactional data.

For example, log file correlator 180 may correlate a first portion of transactional data with a first portion of non-transactional data based on a timestamp of associated transactions and events. The first portion of non-transactional data may include a screenshot of the display at the time of a mouse click. The screenshot may depict the text “download,” “upload,” “remove,” a list of filenames (e.g., “2015_quarterly_reports.docx” and “2016_quaterly_reports.docx”), and shows that the cursor selected “OK” on a confirmation prompt. Log file correlator 180 may infer which action of the possible actions depicted in the screenshot (download, upload or remove) that the user took. In some embodiments, this inference may be based on a measurement of the distance from the action text to the cursor. For example, log file correlator 180 may determine that the cursor was closest in distance to the text “download,” and farther away from the text “upload” or “remove.” In such a scenario, log file correlator 180 may determine that the user action associated with the first portion of transactional data is “download.”

In a similar manner, log file correlator 180 may identify a possible user action for each group. For example, log file correlator 180 may examine all non-transactional data for a group by measuring the distances between an event on the user's display and user actions depicted in the display. Based on this information, log file correlator 180 may determine the probability of each user action depicted in the display. For example, log file correlator 180 may determine that the cursor was closest to the action text “download” in 82% of the screenshots related to a particular group. Log file correlator may also determine that the cursor was closest to the action text “upload” in 2% of the screenshots related to the group, and that the cursor was closest to the action text “rename” in 16% of the screenshots related to the group. Based on this information, log file correlator 180 may identify that the particular group is related to the user action “download” because its associated probability is the highest amongst the group. Although this disclosure recites a particular way of inferring a user action from non-transactional data, this disclosure recognizes inferring a user action from non-transactional data in any suitable manner.

Log file correlator 180 may identify two or more user actions for a group based on the non-transactional data in some embodiments. For example, log file correlator 180 may identify that the group is related to the user actions “download,” “upload,” and “rename” when each of these user actions have the same probability (e.g., 33% probability that the user action is download, 33% probability that the user action is upload, and 33% probability that the user action is rename). In such a scenario, log file correlator 180 may determine that the user action is unknown for the group. In some embodiments, the log file correlator 180 may flag a group for further processing in response to identifying more than one user action for a group. In response to being flagged, a file monitor may be alerted to manually review the identification.

In some embodiments, identifying the possible user action comprises a threshold analysis. For example, log file correlator 180 may select a particular user action as the possible user action when there is an 80% probability that the particular user action was taken by a user. In reference to the above example relating to identifying a possible user action for each group, log file correlator 180 may identify “download” as the possible user action for the group because its associated probability (82%) exceeded the threshold (80%). In some other embodiments, log file correlator 180 may determine that the user action is “unknown” if none of the probabilities associated with one or more possible user actions exceeds the threshold. If log file correlator 180 determines that the user action is “unknown” for the group, log file correlator 180 may flag the group for manual review. In some embodiments, the method 200 may continue to a step 260.

At a step 260, log file correlator 180 labels each group of the one or more groups. In some embodiments, each group is labeled based at least in part on the identification performed in step 250. For example, log file correlator 180 may label a group “upload file” in response to identifying that the group likely corresponds to the user action “upload file.” In some embodiments, each portion in the group may be labeled based on the identification of the corresponding user action. In some embodiments, the method 200 ends in a step 265.

Accordingly, by correlating non-transactional data with transactional data, log file correlator 180 may annotate client-server transactions. As a result, a human monitoring transactional data may be able to determine a possible user action corresponding to each group of portions of transactions.

In operation, a user of a client computer (e.g., client computer 110) begins using remote service software that accesses a network (e.g., HTTP network 120). As the user interacts with the software, transactional and non-transactional data may be generated and recorded. As described above, proxy server 130 may record the transactional data and cause it to be stored on monitoring device 140. In some embodiments, a communication interface of monitoring device 140 receives transactional data 150 from proxy server 130 and a processor of monitoring device 140 causes the transactional data 150 to be stored in an internal storage.

Log file correlator 180 is configured to partition the transactional data into bursts in some embodiments. FIG. 3 illustrates a stream of transactional data 305 for partitioning. As described above, transactional data 305 may contain a plurality of request-response pairs that are associated with one or more user actions. Although this disclosure may describe the transactional data as being direct exchanges between a browser and a server, the request-response pairs may operate over a plurality of channels of communications simultaneously. For example, FIG. 3 shows that the transactional data is communicated over three channels 340 (e.g., communication channels 340a-c).

As depicted in FIG. 3, the stream of transactional data 305 relates to two separate user actions: a “login” action indicated as “A” and a “remove file” action indicated as “B”. The vertical dotted lines represent a user interaction 320 with the web page. For example, interaction 320a may correspond to a user clicking the “login” button on a web page. As another example, interaction 320b may correspond to a user clicking a file and interaction 320c may correspond to a user clicking the “remove” button on a web page.

As described earlier, a single user action may be associated with one or more transactions that correspond to one or more events. As used herein, an event refers to any user interaction with client computer 110 that causes a change in software state or generates a software output. As depicted in FIG. 3, each request-response pair constitutes a single transaction 330 and includes a request (indicated as a black box) and a response (indicated as a white box). Although some user actions may comprise a single transaction 330, some user actions comprise more than one transaction (see e.g., login action “A” and remove action “B”). For example, as depicted in FIG. 3, the “remove file” action B includes four transactions 330g-j which may correspond to the following events: (1) selection of a file; (2) indication of deletion of the file; and (3) confirmation of the deletion of the file; and (4) page refresh.

The transactional data may be divided into portions that correspond to a particular user action. For example, in some embodiments, log file correlator 180 is operable to partition transactional data 305 into bursts 310 (e.g., burst 310a and 310b). In some embodiments, transactional data 305 is partitioned based on a timestamp assigned to a particular transaction 330.

Generally, a user takes actions sequentially such that the user interacts with software and waits for a response from HTTP server before taking another action. For example, a user may send a request to fetch a web page and wait for HTTP server to retrieve the web page before attempting to login. Typically, a single user interaction generates a series of transactions in rapid succession that are separated by fractions of a second; these very short intervals are distinguishable from the relatively long intervals between user interactions. Thus, transactional data 305 tends to be bursty—each transaction may be followed by a short or long interval, wherein a short interval may indicate that the transaction is responsive to a single user interaction and a long interval may indicate the transaction corresponds to a new user action. Based on these directives, log file correlator 180 may identify short and long intervals and partition transactional data 150 accordingly.

Log file correlator 180 may use the timestamps associated with the transactional data 305 to identify an interval. In some embodiments, log file correlator 180 clusters all transactions occurring in quick succession as a single burst. For example, as depicted in FIG. 3, transactional data 305 shows a plurality of transactions 330a-f closely related in time that correspond to the “login” action A, followed by an identifiable period of inaction 350, followed by a plurality of transactions 330g-j closely related in time that correspond to the “remove file” action B. As such, transactions 330a-f may be clustered in a first burst 310a and transactions 330g-j may be clustered in a second burst 310b. Thus, one or more transactions 330 may be identified as being related (e.g., by time) and may be clustered into a single burst 310. As described above, the burst 310 is likely to be indicative or suggestive of a single user action. For example, burst 310a is likely to correspond to user action A and burst 310b is likely to correspond to user action B.

Log file correlator 180 may sort bursts 310 into one or more groups in some embodiments. Sorting of bursts may be based on similarity of one burst to another. In some embodiments, bursts are sorted into one or more groups based on similarity of the non-transactional data comprised in each burst. In other embodiments, bursts are sorted into one or more groups based on similarity of the transactional data comprised in each burst. For example, a first burst may include the following transactional data of TABLE 1:

TABLE 1
BURST 1

| REQUEST | RESPONSE |
|---|---|
| Select “Compose” Email by | Present Email Composer |
| Clicking Compose | |
| Hover over text displaying | Present informational tag |
| “To” | “Show Contacts” |
| Click text displaying “To” | Present Address Book |
| Select Contact from Address | Present Email Composer with |
| Book | Contact listed as addressee |
| Type Message using Keyboard | Present Message |
| into Message Box | |
| Click “Send” | Present Inbox |

A second burst may include the following transactional data of TABLE 2:

TABLE 2
BURST 2

| REQUEST | RESPONSE |
|---|---|
| Select “Compose” Email by | Present Email Composer |
| Clicking Compose | |
| Click text displaying “To” | Present Address Book |
| Select Contact from Address | Present Email Composer with |
| Book | Contact listed as addressee |
| Type Message using Keyboard | Present Message |
| into Message Box | |
| Drag File Icon from Desktop | Display text “DROP FILES |
| into Message Box | HERE” |
| Drop File Icon into Message | Present Composer with |
| Box | Attachment displayed |
| Click “Send” | Present Inbox |

Log file correlator 180 may compare the transactional data of BURST 1 and BURST 2 and determine that these bursts are similar and belong in the same group. For example, log file correlator 180 may determine that BURST and BURST 2 are similar, and therefore belong in the same group, because they share five identical request-response pairs.

Although this disclosure describes and depicts transactional information in human-readable format, this is not the typical format for transactional data. In most cases, transactional data is meaningless to a human. In some cases, transactional data is completely cryptic.

Taking FIG. 3 as another example, log file correlator 180 may determine that first burst 310a is not similar to second burst 310b because transactions 330a-f are not similar enough to transactions 330g-j. In such a case, log file correlator 180 may continue to compare first burst 310a and second burst 310b to other bursts 310 in the stream of transactional data 305. As described above, this disclosure recognizes sorting bursts in any suitable manner. In some embodiments, each burst 310 of transactional data 305 may be in a group comprising one or more similar bursts 310. In other embodiments, one or more bursts 310 may comprise its own group (e.g., when burst 310 is not similar to any other burst 310 in transactional data 305).

In certain circumstances, it may be desirable to determine the user action is associated with a group. As described above, it may be difficult to determine what user action is associated with a group because the response-request pairs may not be indicative of a single user action. Thus, this disclosure recognizes correlating non-transactional data with transactional data to facilitate the annotation of client-server transactional data.

Log file correlator 180 may identify a possible user action that corresponds to each group in some embodiments. For example, log file correlator 180 may identify that a group containing BURST 1 and BURST 2 above likely correspond to the user action “send email.” In some embodiments, identifying whether a user action corresponds to a group is based on non-transactional data.

FIG. 4 illustrates an internal representation of a display related to a hover event. As described above, event collector 160 of client computer 110 may capture non-transactional data, such as the internal representation depicted in FIG. 6. In some embodiments, event collector 160 captures all non-transactional data associated with the display. In other embodiments, event collector 160 captures non-transactional data associated with only a portion of the display. For example, event collector 160 may capture non-transactional data associated with portions of a web page that the user interacted with (nodes in a direct hierarchy) and portions that a user could have interacted with (nodes in 1-level of depth from the direct hierarchy), and exclude the non-transactional data associated with the remaining portions of the web page.

As depicted in FIG. 4, event collector 160 captures non-transactional data associated with nodes of a web page in which a user interacted (shaded nodes) and nodes in which a user could have interacted (white nodes outlined in solid lines). For example, nodes 405 may represent a mouse click event while node 410 may represent a hover event. As depicted in FIG. 4, event collector 160 does not capture the non-transactional data 170 associated with the other nodes (white nodes outlined in broken lines). Using this model, event collector 160 may likely collect information relevant to determining a user action while ignoring information that may not be relevant to determining a user action.

As described above, non-transactional data 170 may include a timestamp for a user event, data regarding the trigger for the user event, state of the display at the time of the user event, and/or location within the display at which the user event occurred. In some embodiments, event collector 110 may be configured to scrape all or part of the visual of a web page with every user interaction. Because the non-transactional data also includes a location for the event, log file correlator 180 may determine what the user was interacting with on the web page at a particular time.

For example, in FIG. 4, event collector 160 captured non-transactional data 170 related to hover event 410. The event log may display all relevant non-transactional data 170 associated with this event in human-readable format. For example, event log may display:

Event Log

| Timestamp | Trigger | Node Location | Node Description |
|---|---|---|---|
| 13:01 | hover | 16 | “Subtask Notes” |

Using the non-transactional data 170 from the event log, log file correlator 180 may identify an event. For example, here log file correlator 180 may identify that a user of client computer 110 hovered over a “Subtask Notes” node at 13:01.

This identification may then be used to correlate the event to a specific transaction. This correlation may be based on the timestamps associated with the event and transactions. Thus, log file correlator 180 may determine that a particular transaction corresponds to a specific event.

As an example, a user may wish to download a file and clicks a “download” button on a web page. Although the transactional data associated with this user interaction may not recite “download,” the web page does. The event collector 160 may capture the non-transactional data associated with this mouse click. For example the event collector 160 may capture the visual of the web page, the time of the mouse click, and the location of the mouse click). Log file correlator 180 may then determine that the user clicked at a particular point on the page, and, the text located at the point at which the user clicked was labeled “download.” As a result, the log file correlator 180 may determine that the transaction sharing the same timestamp as the event should be associated with the word “download.” Accordingly, non-transactional data 170 may be correlated with transactional data 150 to give meaning to each transaction within a stream of client-server transactions.

Log file correlator 180 is configured to identify that a group corresponds to a particular user action in some embodiments. For example, log file correlator 180 may identify that GROUP 1 relates to the user action “send email.” In some embodiments, log file correlator 180 identifies that a group corresponds to a particular user action based on the non-transactional data 170.

As detailed above, log file correlator 180 may identify an event corresponding to each transaction by correlating the non-transactional 170 and transactional data 150. Log file correlator 180 may then select one of the identified events as the user action corresponding to the group. For example, log file correlator 180 may select an identified event based on the number of times the event appears within a group. As another example, log file correlator 180 may selects an identified event based on a threshold analysis.

Log file correlator 180 may be further configured to determine that particular transactions within a group relate to meaningless events. For example, log file correlator 180 may determine that a transaction that appears in a plurality of groups is not indicative of a user action and should be excluded from further processing. In some embodiments, log file correlator 180 may be configured to ignore transactions corresponding to meaningless events. For example, log file correlator 180 may be configured to ignore meaningless events when selecting one of the identified events. As a result, the user action identified for the group will not be based on an event that log file correlator 180 determined to be meaningless.

As described above in reference to FIG. 2, log file correlator 180 may also receive non-transactional data that is more difficult to correlate with transactional data (e.g., when the non-transactional data comprises more than one possible user action). As such, this disclosure recognizes that log file correlator 180 may identify a possible user action taken by a user by determining the probability or likelihood that a particular user action occurred based on the non-transactional data.

Log file correlator 180 is configured to label a group based at least on the user action identified for that group in some embodiments. As an example, log file correlator 180 may label a first group “SENDING EMAILS” based on the identification that the transactions in the first group likely relate to the user action “sending emails.” In some embodiments, each group may be labeled differently from every other group. In some embodiments, two or more groups may share the same label. In some embodiments, a group may be labeled with more than one user action. In such cases, log file correlator 180 may flag such group for further manual processing.

FIGS. 5A-5D illustrate different flows of annotating client-server transactions. As used in reference to FIGS. 5A-5D, the terms “Burst Identification,” “Burst Clustering,” and “Action Labeling” refer to different stages of processing the transactional and non-transactional data according to embodiments of the present disclosure. “Burst Identification” as used in reference to FIGS. 5A-5D refers to the partitioning of transactional data into bursts. “Burst Clustering” as used in reference to FIGS. 5A-5D refers to the clustering of bursts into one or more groups (each group indicative of a user action). “Action Labeling” as used in reference to FIGS. 5A-5D refers to the labeling of the groups based on identification that the group corresponds to a particular user action.

FIG. 5A illustrates the three processing stages occurring sequentially. For example, upon receiving the transactional and non-transactional information, log file correlator 180 initiates the Burst Identification stage 505 wherein one or more bursts are generated from transactional data. Log file correlator 180 may then initiate the Burst Clustering stage 510 wherein the one or more bursts are sorted into one or more groups. Log file correlator 180 may then initiate the Action Labeling stage 515 wherein the one or more bursts are labeled based on the user action that the group is associated with.

FIGS. 5B and 5C illustrate processing flows wherein two processing stages occur simultaneously and one processing stage occurs sequentially. As used herein, “simultaneously” means that the results of processing stages are dependent on each other. FIG. 5B illustrates that the Burst Identification 505 and Burst Clustering 510 stages may occur simultaneously and are followed by the Action Labeling stage 515. FIG. 5C illustrates the Burst Identification Stage occurring prior to the simultaneous initiation of the Burst Clustering 510 and Action Labeling 515 stages.

Finally, FIG. 5D illustrates that the three processing stages may occur simultaneously. As such, the system may initiate the Burst Identification stage 505, the Burst Clustering Stage 510, and the Action Labeling stage 515 simultaneously.

FIG. 6 illustrates an example computer system 600. As described above, monitoring device 140 may be a computer system such as computer system 600. Computer system 600 may be any suitable computing system in any suitable physical form. As example and not by way of limitation, computer system 600 may be a virtual machine (VM), an embedded computer system, a system-on-chip (SOC), a single-board computer system (SBC) (e.g., a computer-on-module (COM) or system-on-module (SOM)), a desktop computer system, a laptop or notebook computer system, a mainframe, a mesh of computer systems, a server, an application server, or a combination of two or more of these. Where appropriate, computer system 600 may include one or more computer systems 600; be unitary or distributed; span multiple locations; span multiple machines; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

One or more computer systems 600 may perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

Computer system 600 may include a processor 610, memory 620, storage 630, an input/output (I/O) interface 640, a communication interface 650, and a bus 660 in some embodiments, such as depicted in FIG. 6. Although this disclosure describes and illustrates a particular computer system having a particular number of particular components in a particular arrangement, this disclosure contemplates any suitable computer system having any suitable number of any suitable components in any suitable arrangement.

Processor 610 includes hardware for executing instructions, such as those making up a computer program, in particular embodiments. For example, processor 610 may execute Log file correlator 180 to facilitate the annotation of client-server transactions 150. As an example and not by way of limitation, to execute instructions, processor 610 may retrieve (or fetch) the instructions from an internal register, an internal cache, memory 620, or storage 630; decode and execute them; and then write one or more results to an internal register, an internal cache, memory 620, or storage 630. In particular embodiments, processor 610 may include one or more internal caches for data, instructions, or addresses. This disclosure contemplates processor 610 including any suitable number of any suitable internal caches, where appropriate. As an example and not by way of limitation, processor 610 may include one or more instruction caches, one or more data caches, and one or more translation lookaside buffers (TLBs). Instructions in the instruction caches may be copies of instructions in memory 620 or storage 630, and the instruction caches may speed up retrieval of those instructions by processor 610. Data in the data caches may be copies of data in memory 620 or storage 630 for instructions executing at processor 610 to operate on; the results of previous instructions executed at processor 610 for access by subsequent instructions executing at processor 610 or for writing to memory 620 or storage 630; or other suitable data. The data caches may speed up read or write operations by processor 610. The TLBs may speed up virtual-address translation for processor 610. In particular embodiments, processor 610 may include one or more internal registers for data, instructions, or addresses. This disclosure contemplates processor 610 including any suitable number of any suitable internal registers, where appropriate. Where appropriate, processor 610 may include one or more arithmetic logic units (ALUs); be a multi-core processor; or include one or more processors 175. Although this disclosure describes and illustrates a particular processor, this disclosure contemplates any suitable processor.

Memory 620 may include main memory for storing instructions for processor 610 to execute or data for processor 610 to operate on. As an example and not by way of limitation, computer system 600 may load instructions from storage 630 or another source (such as, for example, another computer system 600) to memory 620. Processor 610 may then load the instructions from memory 620 to an internal register or internal cache. To execute the instructions, processor 610 may retrieve the instructions from the internal register or internal cache and decode them. During or after execution of the instructions, processor 610 may write one or more results (which may be intermediate or final results) to the internal register or internal cache. Processor 610 may then write one or more of those results to memory 620. In particular embodiments, processor 610 executes only instructions in one or more internal registers or internal caches or in memory 620 (as opposed to storage 630 or elsewhere) and operates only on data in one or more internal registers or internal caches or in memory 620 (as opposed to storage 630 or elsewhere). One or more memory buses (which may each include an address bus and a data bus) may couple processor 610 to memory 620. Bus 660 may include one or more memory buses, as described below. In particular embodiments, one or more memory management units (MMUs) reside between processor 610 and memory 620 and facilitate accesses to memory 620 requested by processor 610. In particular embodiments, memory 620 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 620 may include one or more memories 180, where appropriate. Although this disclosure describes and illustrates particular memory, this disclosure contemplates any suitable memory.

Storage 630 may include mass storage for data or instructions. As an example and not by way of limitation, storage 630 may include a hard disk drive (HDD), a floppy disk drive, flash memory, an optical disc, a magneto-optical disc, magnetic tape, or a Universal Serial Bus (USB) drive or a combination of two or more of these. Storage 630 may include removable or non-removable (or fixed) media, where appropriate. Storage 630 may be internal or external to computer system 600, where appropriate. In particular embodiments, storage 630 is non-volatile, solid-state memory. In particular embodiments, storage 630 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 630 taking any suitable physical form. Storage 630 may include one or more storage control units facilitating communication between processor 610 and storage 630, where appropriate. Where appropriate, storage 630 may include one or more storages 140. Although this disclosure describes and illustrates particular storage, this disclosure contemplates any suitable storage.

I/O interface 640 may include hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 185 for them. Where appropriate, I/O interface 640 may include one or more device or software drivers enabling processor 610 to drive one or more of these I/O devices. I/O interface 640 may include one or more I/O interfaces 185, where appropriate. Although this disclosure describes and illustrates a particular I/O interface, this disclosure contemplates any suitable I/O interface.

Communication interface 650 may include hardware, software, or both providing one or more interfaces for communication (such as, for example, packet-based communication) between computer system 600 and one or more other computer systems 600 or one or more networks (e.g., network 100). As an example and not by way of limitation, communication interface 650 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 650 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 650 for any of these networks, where appropriate. Communication interface 650 may include one or more communication interfaces 190, where appropriate. Although this disclosure describes and illustrates a particular communication interface, this disclosure contemplates any suitable communication interface.

Bus 660 may include hardware, software, or both coupling components of computer system 600 to each other. As an example and not by way of limitation, bus 660 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 660 may include one or more buses 212, where appropriate. Although this disclosure describes and illustrates a particular bus, this disclosure contemplates any suitable bus or interconnect.

The components of computer system 600 may be integrated or separated. In some embodiments, components of computer system 600 may each be housed within a single chassis. The operations of computer system 600 may be performed by more, fewer, or other components. Additionally, operations of computer system 600 may be performed using any suitable logic that may comprise software, hardware, other logic, or any suitable combination of the preceding.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A system for annotating client-server transactions, the system comprising:
an interface configured to receive non-transactional data and a stream of transactional data, wherein:
the non-transactional data comprises information associated with a plurality of events on a computer that correspond to one or more actions taken by a user of the computer;
the stream of transactional data comprises one or more transactions between a computer and a server and are associated with the plurality of events;
a processor configured to:
partition the stream of transactional data into a plurality of portions;
sort the plurality of portions into one or more groups based on similarity of one portion of the plurality of portions to another portion of the plurality of portions;
identify, for each group of the one or more groups, based on the non-transactional data, a possible action of the one or more actions taken by the user; and
label each group of the plurality of groups based at least in part on the identification.

2. The system of claim 1, wherein the processor is further configured to identify the possible action of the one or more actions to which each group corresponds by correlating the non-transactional data with the transactional data.

3. The system of claim 2, wherein the processor is further configured to identify the possible action taken by the user by determining a probability that the non-transactional data corresponds to the transactional data.

4. The system of claim 1, wherein the non-transactional data comprises one or more of:
a timestamp for each of the plurality of events;
a trigger for each of the plurality of events;
information related to a display of the computer at the time of each of the plurality of events; and
information related to a location within the display at which each of the plurality of events occurred.

5. The system of claim 1, wherein the processor partitions the stream of transactional data based on one or more timestamps associated with the one or more transactions.

6. The system of claim 1, wherein the processor determines whether one portion of the plurality of portions is similar to another portion of the plurality of portions based on a threshold.

7. The system of claim 1, wherein the processor is further configured to label each of the one or more transactions based on the identification.

8. A method for annotating client-server transactions with a computer executing software, the method comprising:
receiving a stream of transactional data associated with a plurality of events on the computer, wherein the plurality of events correspond to one or more actions taken by a user of a computer;
partitioning the stream of transactional data into a plurality of portions;
sorting the plurality of portions into one or more groups based on the similarity of one portion of the plurality of portions to another portion of the plurality of portions;
receiving non-transactional data from the computer, wherein the non-transactional data comprises information about the plurality of events;
identifying, for each group of the one or more groups, based on the non-transactional data, a possible action of the one or more actions taken by the user; and
labeling each group based on the identification.

9. The method of claim 8, wherein identifying the possible action of the one or more actions to which each group corresponds comprises correlating the non-transactional data with the transactional data.

10. The method of claim 9, wherein identifying the possible action taken by the user comprises determining a probability that the non-transactional data corresponds to the transactional data.

11. The method of claim 8, wherein the non-transactional data may comprise one or more of:
a timestamp for each of the plurality of events;
a trigger for each of the plurality of events;
information related to a display of the computer at the time of each of the plurality of events; and
information related to a location within the display at which each of the plurality of events occurred.

12. The method of claim 8, wherein partitioning the stream of transactional data is based on one or more timestamps associated with the one or more transactions.

13. The method of claim 8, wherein determining whether one portion of the plurality of portions is similar to another portion of the plurality of portions is based on a threshold.

14. The method of claim 8, wherein the non-transactional data is received from an event collector on the computer.

15. One or more computer-readable non-transitory storage media in one or more computing systems, the media embodying logic that is operable when executed to:
partition a stream of transactional data into a plurality of portions, wherein the stream of transactional data is associated with a plurality of events on a computer, wherein the plurality of events correspond to one or more actions taken by a user of the computer;
sort the plurality of portions into one or more groups based on the similarity of one portion of the plurality of portions to another portion of the plurality of portions;
identify, for each group of the one or more groups, based on non-transactional data, a possible action of the one or more actions; and
label each group of the plurality of groups based on the identification.

16. The media of claim 15, wherein identifying the possible action of the one or more actions to which each group corresponds comprises correlating the non-transactional data with the transactional data.

17. The media of claim 16, wherein identifying the possible action taken by the user comprises determining a probability that the non-transactional data corresponds to the transactional data.

18. The media of claim 15, wherein the non-transactional data comprises one or more of:
a timestamp for each of the plurality of events;
a trigger for each of the plurality of events;
information related to a display of the computer at the time of each of the plurality of events; and
information related to a location within the display at which each of the plurality of events occurred.

19. The media of claim 15, wherein partitioning the stream of transactional data is based on one or more timestamps associated with the one or more transactions.

20. The media of claim 15, wherein determining whether one portion of the plurality of portions is similar to another portion of the plurality of portions is based on a threshold.
